(19) United States
(12) Patent Application Publication
(10) Pub. No.: US 2005/0098637 A1
(43) Pub. Date: May 12, 2005

(54) Memory card control chip of a multi-control interface

(76) Inventor: Chien-Yuan Chen, Banchiau City (TW)

Correspondence Address: TROXELL LAW OFFICE PLLC, SUITE 1404, 5205 LEESBURG PIKE, FALLS CHURCH, VA, 22041, US

(21) Appl. No.: 10/984,863

(22) Filed: Nov. 10, 2004

(30) Foreign Application Priority Data
Nov. 12, 2003 (TW) 93131721

(51) Int. Cl. G06K 19/06

(52) U.S. Cl. 235/492

(57) ABSTRACT

The present invention provides a memory card control chip of a multi-control interface. The control chip contains a flash memory control interface and a read-only memory control interface, with at least one flash memory added to the flash memory control interface, and the combination of the read-only memory with the control chip into a whole chip, such that the manufacturing process can be simplified, the manufacturing cost can be lowered, and the memory card can have the dual function of multiple read/write and read-only.

### BACKGROUND OF THE INVENTION

a) Field of the Invention

The present invention relates to a memory card control chip of a multi-control interface, and more particularly to a memory card control chip having both a flash memory control interface and a read-only memory control interface.

b) Description of the Prior Art

As the increase of requirement of the randomness of electronic data transmission, the relationship of a memory card with daily life is getting closer. A memory card, or called smart card, digital card, which is widely used today, is a data storage medium of new generation, which has the features of compact size, high storage capacity, and fast transmission speed, and is especially applied to multimedia data storage and transmission, such as in a digital camera, cellular phone, stereo, computer, and personal digital assistant. There are two kinds of memory card available in the current market, including a multiple read/write flash memory card, and a read-only memory card. Due to the necessity of manufacturing these different memory cards separately, the cost of raw material and the manufacturing time can not be lowered, and because a user needs to carry different memory cards, it will also cause inconvenience to the user.

### SUMMARY OF THE INVENTION

The primary object of the present invention is to provide a memory card control chip of a multi-control interface, in which both a flash memory control interface and a read-only memory control interface are installed on a memory card control chip, such that the memory card can have dual function of multiple read/write and read-only at the same time.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of the implementation of the present invention.

FIG. 2 shows a control block diagram of the present invention.

### DETAILED DESCRIPTION OF THE PREFERRED EMBODIMENTS

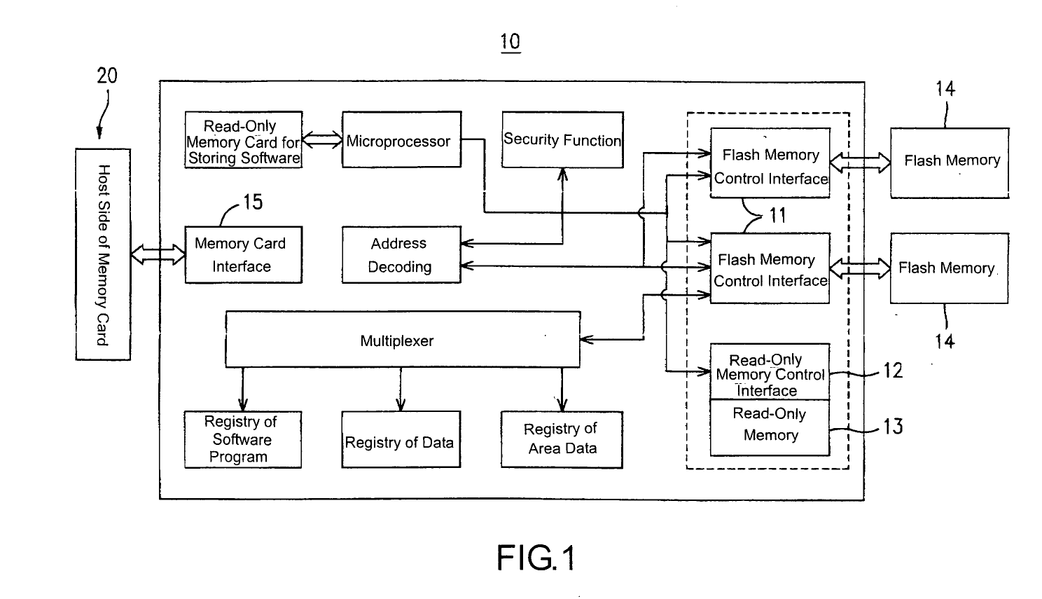

Referring to FIG. 1, a memory card control chip of a multi-control interface 10 contains a flash memory control interface 11 and a read-only memory control interface 12, with at least one flash memory 14 added to the flash memory control interface 11. With the installation of the flash memory control interface 11 and the read-only memory control interface 12, the memory card will have the dual function of multiple read/write and read-only. In addition, the control chip 10 has a memory card interface 15 to connect with an external host side 20 of the memory card.

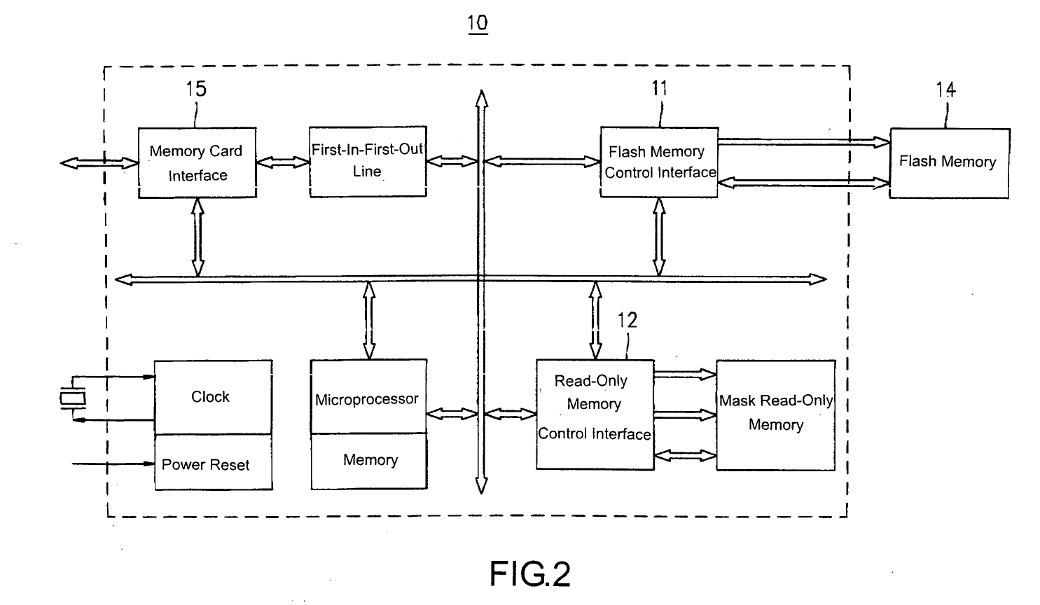

Referring to FIG. 2, it shows a control block diagram of the present invention. As the size of all memory is changeable, all the memory can be divided into a main area and a secondary area, with the main area set up for a flash memory 14, for saving the flash memory 14 into a main boot sector. When a data storage system starts up, the main boot sector will be accessed first, followed by file system of two memory areas, such that the data disk can be accessed normally. If data needs to be written to the read-only memory 13, the read-only memory control interface 12 will set up a “Write Protection Error” message.

Moreover, due to the similarity of manufacturing process for the read-only memory 13 with that for the control chip 10, the read-only memory 13 will be installed into the control chip 10, and combined with the control chip 10 into a whole chip, such that the manufacturing process can be simplified, the manufacturing cost can be lowered, and in manufacturing the control chip 10, an operational manual, and a product introduction document can be burnt into the read-only memory 13 of the control chip 10, in order to save the cost of printing operational manuals or technical handbooks, and provide for the convenience of carrying and the easiness of data querying.

It is of course to be understood that the embodiments described herein is merely illustrative of the principles of the invention and that a wide variety of modifications thereto may be effected by persons skilled in the art without departing from the spirit and scope of the invention as set forth in the following claims.

1. A memory card control chip of a multi-control interface, with its features of having a flash memory control interface and a read-only memory control interface.

2. The memory card control chip of a multi-control interface according to claim 1, wherein at least one flash memory is added to the flash memory control interface.

3. The memory card control chip of a multi-control interface according to claim 1, wherein the control chip is combined with the read-only memory into a whole chip.
